(19) United States
(12) Patent Application Publication
(10) Pub. No.: US 2010/0312648 A1
(43) Pub. Date: Dec. 9, 2010

(54) System and method for profile based search and correlation of customers, vendors, distributors, consultants and products

(76) Inventors: Ryan Gerome, Parker, CO (US); Sreeram N. Govindakrishnan, Littleton, CO (US); Naresh Devnani, Parker, CO (US)

Correspondence Address: Anthony J. Serventi, 31268 Cedar Ridge Lane, Madison Heights, MI, 48071, US

(21) Appl. No.: 12/655,849

(22) Filed: Jan. 9, 2010

Related U.S. Application Data
(60) Provisional application No. 61/204,742, filed on Jan. 10, 2009.

(51) Int. Cl. G06Q 30/00

(52) U.S. Cl. 705/14.66

(57) ABSTRACT

The invention relates to an automated system and method for profile based search and correlation of customers to vendors, distributors, consultants having information technology products, such as hardware, software and network solutions. The invention disclosed herein includes a system for correlating a customer having a project to a recommendation, which may include at least one of a vendor having a vendor product and/or a consultant having a consultant product, if available. The system preferably comprises means for inputting and displaying customer profile information, wherein an information database stores the customer profile information; means for inputting customer project information into the information database, the customer project information comprising project specification data detailing the project parameters; means for displaying vendor profile information to the vendor, the vendor profile information comprising vendor identity information, wherein the information database stores the vendor profile information; means for inputting at least one vendor product specification into the information database; means for displaying consultant profile information to the consultant, the consultant profile information comprising consultant identity information, wherein the information database stores the consultant profile information; means for inputting at least one consultant product specification into the information database. The system correlates each product specification information to comprise at least one product rating and the system processes project information in the information database to correlate the project information to at least one recommendation and displays each of the recommendations to the customer

### CROSS-REFERENCE TO RELATED APPLICATIONS

This application claims the benefit of U.S. Provisional Application No. 61/204,742, filed on Jan. 10, 2009. The disclosure of the above application is incorporated herein by reference in its entirety.

### FIELD OF THE INVENTION

The instant invention relates generally to an automated system and method for searching products and correlating customers, vendors, distributors and consultants for such products. More specifically, the invention relates to an automated system and method for profile based search and correlation of customers to vendors, distributors, consultants having information technology (“IT”) products, such as hardware, software and network solutions.

### BACKGROUND

In commerce, the flow of information to and from a customer and vendor is often propagated by a reseller. The reseller works with the customer to determine the product or service best suited to fit a particular project or need of the customer.

The business relationship between the seller of goods and services and the reseller can consist of the reseller participating in a resell program created and managed by the seller. The seller's reseller program will usually consist of margin discounts to the reseller off of the then current seller list price offerings. The opportunity for the reseller is a result of earning gross profit for sales they complete for the seller over the cost charged by the seller. Additionally the reseller can build and charge the end customer separately for additional goods and service offerings that compliment the seller's offerings, thus providing additional value to the end customer and to the seller in the sale process.

There exists a need for a system and method that significantly reduces the need for a highly manual selling process between buyers, i.e. customers, and sellers, including vendors, distributors and consultants, by automating any additional value a reseller could provide to an end customer or seller in the buying and selling process. The system and method preferably will provide buyers a way to derive immediate, relevant and actionable information regarding sellers of goods and services, and develop a request for information/request for a purchase document that is required to get comparable information. Acquiring comparable information relevant to a given project is very time consuming and conventionally can take many weeks or months for buyers to complete.

There exists a need for a system and method that minimizes the cost of creating and managing a resell program for sellers of goods and services. The system and method will significantly reduce the complexity involved in transacting business through resellers for end customers and for the seller of goods and services by automating the research, project management, goods and services selection (or elimination) and transaction of goods and services between the seller of goods and services and the buyer of goods and services. There exists a need for a system and method that 1) instantly automates the value added selling process associated with the IT industry; 2) uses customer, vendor, distributor and consultant profiles to market and correlate who and which companies can use a given technology, why, how it applies, what impact it will have for them, how much it costs and customers ratings; 3) saves time for customers; 4) provides customers with real time information which may be utilized to make decisions regarding goods and services needed for a particular project; and 5) for small sellers, it makes competing with larger more established competitors much more efficient by alleviating the need to work with traditional resellers and by automating the selling process.

The present invention overcomes the deficiencies of prior art by providing a profile based system and method that correlates customers and projects to vendors, distributors, consultants having IT products, such as hardware, software and network solutions. The present invention enables customers to input profile data and project data, which is used to correlate the needs of the customer and project to a seller of goods and/or services. Vendors, distributors and consultants may also input profile data and other data concerning specifications for specific goods, services or other offerings. The system and method correlates the needs of a project to the available offerings and provides the recommendation(s) to the customer, if the search of the data base finds a product or solution that meets the needs of the project. Further, the system and method incorporates various ratings systems that rates the effectiveness of the vendors, distributors, consultants and products, which assists in the final determination of seller and product(s) best suited to meet the needs of the project. Further, because different customers weigh variables according to the needs of the project, the customer may manipulate the weighting of the various factors that the system and method incorporates when correlating the products to the project.

### SUMMARY OF THE INVENTION

Disclosed herein is a system for correlating a customer having a project to a recommendation, which may include at least one of a vendor having a vendor product and/or a consultant having a consultant product, if available. The system preferably comprises means for inputting and displaying customer profile information, wherein an information database stores the customer profile information; means for inputting customer project information into the information database, the customer project information comprising project specification data detailing the project parameters; means for displaying vendor profile information to the vendor, the vendor profile information comprising vendor identity information, wherein the information database stores the vendor profile information; means for inputting at least one vendor product specification into the information database; means for displaying consultant profile information to the consultant, the consultant profile information comprising consultant identity information, wherein the information database stores the consultant profile information; means for inputting at least one consultant product specification into the information database. The system correlates each product specification information to comprise at least one product rating and the system processes project information in the information database to correlate the project information to at least one recommendation and displays each of the recommendations to the customer. The recommendation may be a selected product that meets the needs of the project. The recommendation may also include output information, such as articles, links to websites, product descriptions and the like.

The system may also process project information in the information database to correlate the project information to at least one solution and displays each of the solutions to the customer. A solution is preferably a combination of multiple selected products that provide a unique service when used together in certain configuration(s). Selected products in a solution may originate from multiple vendors, consultants and distributor. The system notifies the customer, in the event a selected product or solution is not available to meet the needs of project and the system is unable to correlate the project information to a selected product. The recommendation may also include output information, such as articles, links to websites, product descriptions and the like. In the event a selected product or solution is not found, the customer may modify one or more criteria of the customer profile or project to search for products and solutions. Also, in the event a selected product or solution is not available, the system may provide output information, such as articles, links to websites, product descriptions and the like.

In a preferred embodiment, the customer inputs the customer project information into a customer preference manager, which allows the customer to review and modify the customer project information as necessary. Further, the customer may add, edit or remove project specification data to allow the customer an opportunity to refine the details of the project. After the customer confirms the project specification data, the customer may assign weight to each detail of the project specification data to further refine the process of correlation between the project information to a recommendation. The customer may adjust the weight of each the detail to allow a review of different scenarios under which the system may display selected products. The customer may save the assigned weights for a given scenario for future reference and consideration. Also, the system may provide the customer with additional considerations for the project. For example, the system may provide the customer with recent technological advances that could influence the project specification and the weight assigned by the customer.

The system of the present invention may further comprise a customer IT portfolio manager, which catalogues the inventory of IT resources, and the configurations, that are implemented in a computer network identified by the customer. The customer IT portfolio manager may comprise data including hardware, software and other IT components specific to the computer network. The customer preferably uses this feature to assess the compatibility of the selected product to the existing computer network.

Preferably, the data from customer profile information, customer project information, including project specification data and weighted preferences, and customer IT portfolio manager are distributed into a recommendation engine which correlates the project information to a recommendation, which may be at least one selected product or solution. The recommendation engine may use one or more of the data elements to correlate one or more selected products based on the data provided by the customer. The recommendation may also include output information, such as articles, links to websites, product descriptions and the like. The system may further include correlating the customer and project to a distributor having a product. The system preferably further comprises means for displaying distributor profile information to the distributor, the distributor profile information comprising distributor identity information, wherein the information database stores the distributor profile information; and means for inputting at least one distributor product specification into the information database.

The invention may be comprised of a computer-assisted and network assisted method including hardware, software and telecommunications components that cooperatively achieve the technical effect of an improved research, project management and transaction system between two or more users, including customers, vendors, distributors and consultants.

A preferred embodiment of the present invention discloses a system and method, wherein the exchange of product information between the customer and the information database is continual, as the customer is immediately provided recommendations with respect to a project. This real time exchange of information allows the customer to continually receive products for consideration and/or purchase. The system and method further comprises a request for quote and quotation for use by the sellers and customer to finalize a transaction for goods and/or services. After the customer selects a product for purchase, the system provides support for the interaction between the customer and the vendor, distributor or consultant (i.e. seller). The customer may receive information related to an offer, such information including pricing, availability, delivery time, warranty and future updates. The customer may make purchase decisions based on this information, as well as, the rating information provided by the system.

Ratings are developed over time as system analysts and customers provide input regarding the various products and advances in IT. This will be a chronological development, wherein the ratings may include all or any of seller ratings, product ratings, execution ratings, external ratings and expert ratings.

### BRIEF DESCRIPTION OF THE DRAWINGS

In order to assist in the understanding of the various aspects of the present invention and various embodiments thereof, reference is now made to the appended drawings, in which like reference numerals refer to like elements. The drawings are exemplary only, and should not be construed as limiting the invention.

FIG. 1 is a flow diagram representation which shows an embodiment of the present invention, wherein a recommendation engine correlates input data to a recommendation;

FIG. 2 is flow diagram representation which shows an embodiment of the present invention, wherein sample input criteria is illustrated;

FIG. 3 is flow diagram representation which shows an embodiment of the present invention, wherein the recommendation engine displays recommendations based on the weighted preferences and ratings inputted by system users, i.e. system internal analysts, customers, vendors, consultants and distributors;

FIG. 4 is a customer profile screen of an embodiment of the present invention;

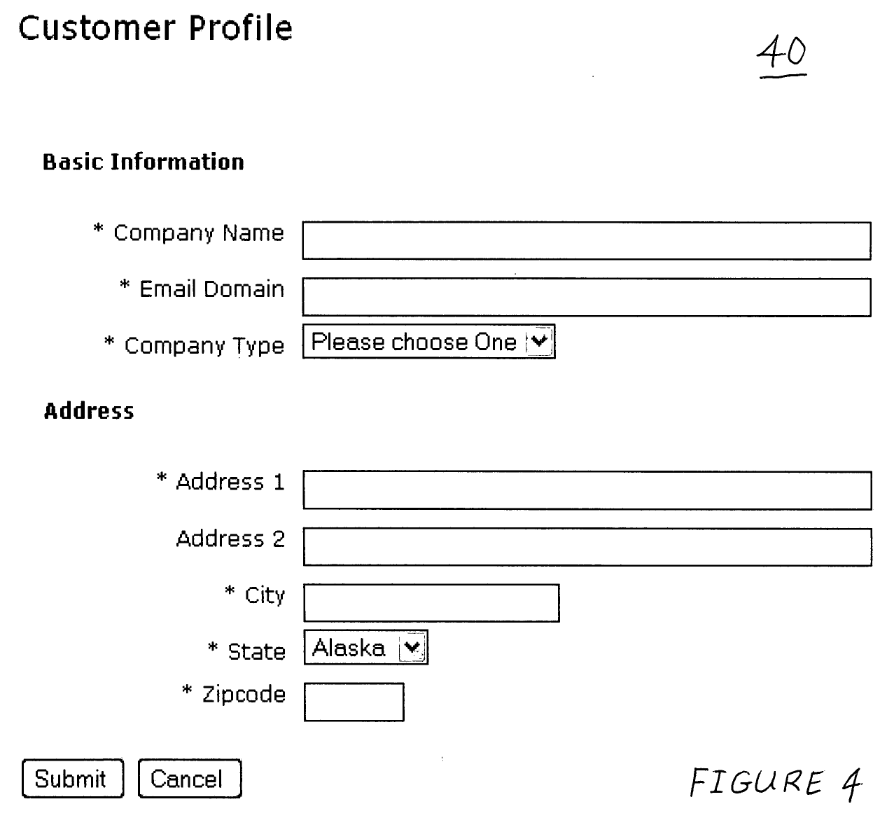

FIG. 5 is a vendor profile screen of an embodiment of the present invention;

FIG. 6 is a consultant profile screen of an embodiment of the present invention;

FIG. 7 is a distributor profile screen of an embodiment of the present invention;

FIG. 8 is a project creation screen of an embodiment of the present invention; and

FIG. 9 is a product creation screen of an embodiment of the present invention.

FIG. 10 is a flow diagram representation which shows an embodiment of the present invention, wherein a customer inputs customer profile information and project information and at least one vendor inputs vendor profile information and at least one product specification information and the recommendation engine correlates input data to a recommendation for the project.

### DETAILED DESCRIPTION OF EMBODIMENTS OF THE INVENTION

The present invention is a system and method which searches profiles and information provided by customers, vendors, distributors and consultants, as well as system analysts, and correlates the results to match a customer project requirements to the product offerings available using a wide array of factors. The factors may be manipulated by the customer to enable the customer to efficiently search and select products that best suit designated parameters for the customer needs. If a product offering is not available to meet the needs of the project requirements, the customer may refine the search criteria until a selected product is found. The system will also provide customers with other optional attributes which may be applicable to the project. This is particularly useful as advances in IT continually develop new solutions to existing technical obstacles. The system will educate and notify the users regarding these technical developments.

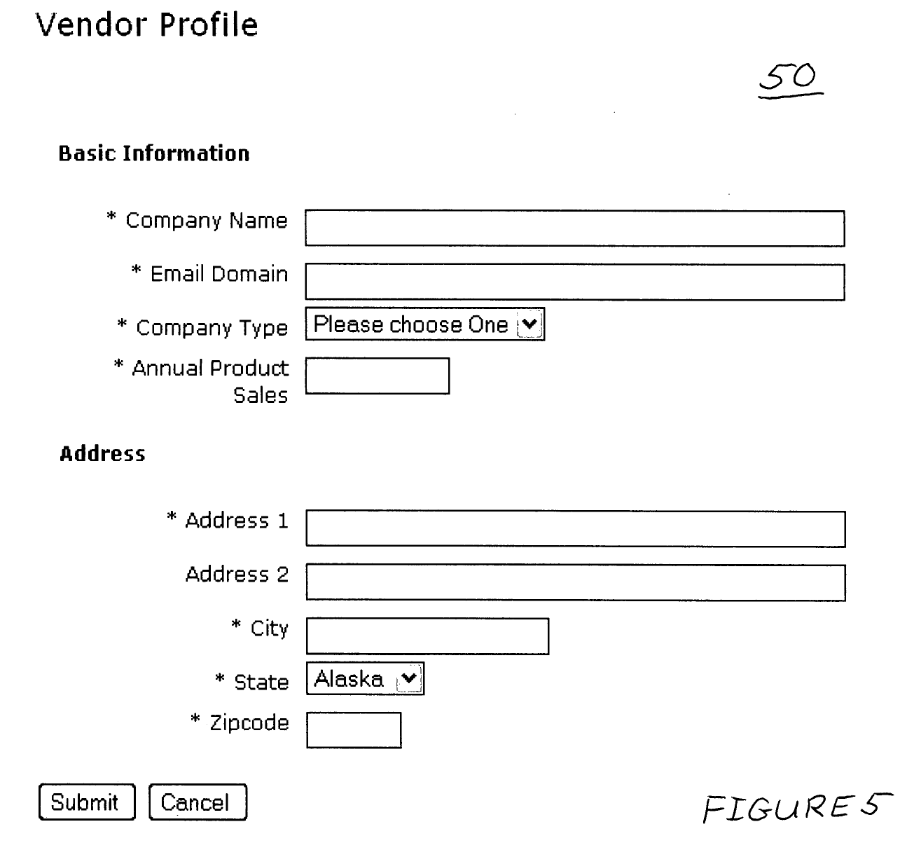

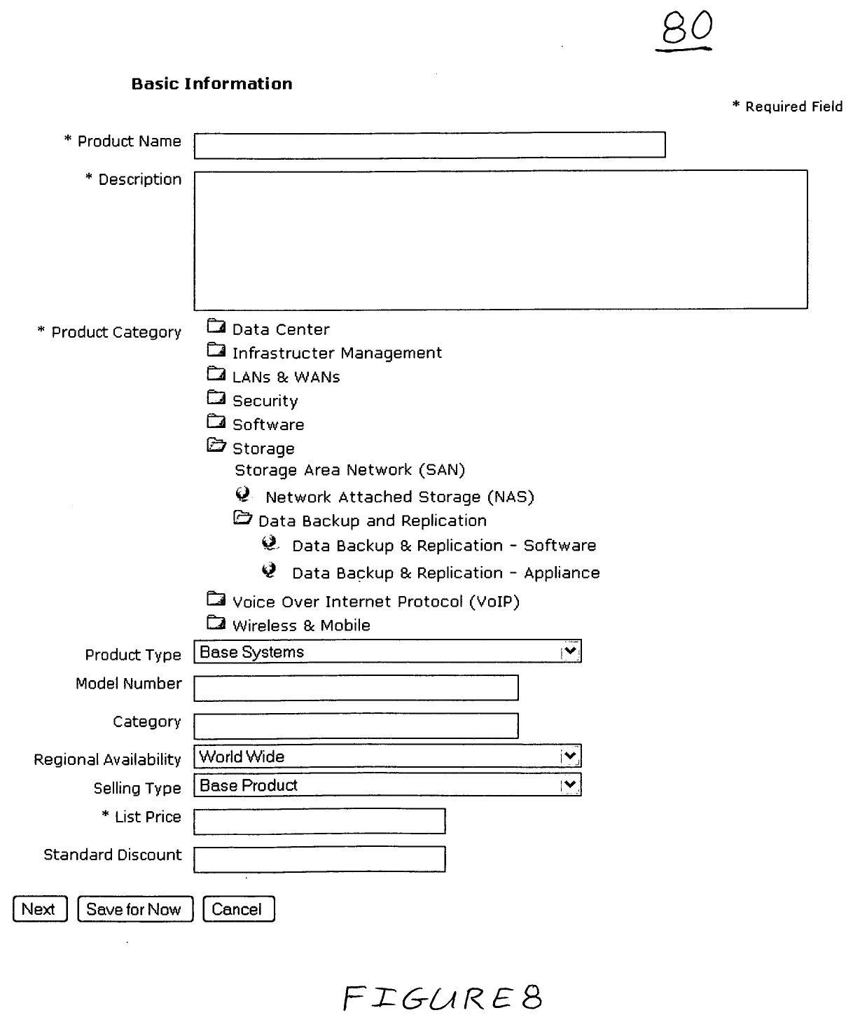

A customer inputs project information into the information database. The project information may include budget, number of users, system compatibility, preferred system, preferred vendor, security needs, technical needs of the system, and any other data considered relevant by the customer. The system is designed to track all customer transactions, product searches and archived research relative to a given project. FIG. 8 illustrates a project creation input screen for use with the current invention. However, it is understood that other input screens and information may be incorporated without deviating from the overall scope of the invention. FIG. 5 illustrates a customer input screen for use with the current invention. However, it is understood that other input screens and information may be incorporated without deviating from the overall scope of the invention.

Vendor profile information may include vendor name, vendor contacts, vendor organizational structure, type of legal entity, size, vendor website, vendor address, signature authorization, annual product sales, vendor ratings and product ratings, and any other data considered relevant. A vendor may be an IT product and solution provider. IT products of a vendor may include software, hardware, and any other products or solutions provided by the vendor. A vendor inputs vendor product information into the information database. The vendor product information may include system compatibility, price, warranty services, customer support, availability, delivery time, and any other data considered relevant. The system saves the information concerning the vendor profile and allows the vendor to update the profile as needed. As vendor product offerings change, the vendor product information will also change. This requires that the vendor update the vendor product information to allow the system to efficiently search and correlate products or solutions to the customer's needs at a given point in time. FIG. 5 illustrates a vendor input screen for use with the current invention. However, it is understood that other input screens and information may be incorporated without deviating from the overall scope of the invention.

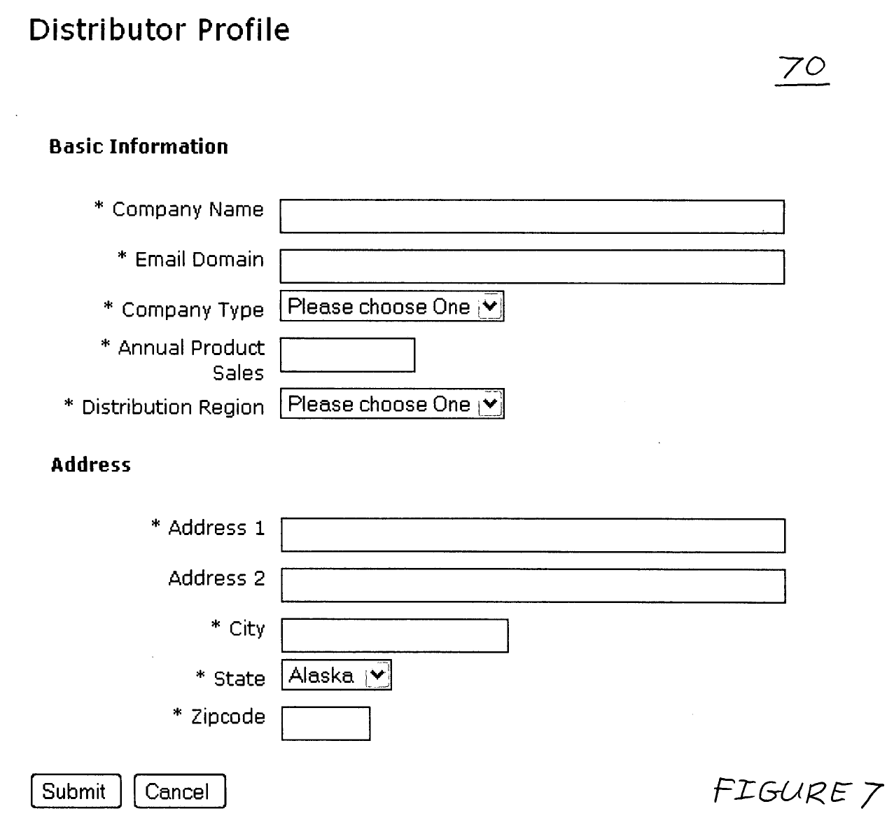

Distributor profile information may include distributor name, distributor contact, distributor organizational structure, type of legal entity, size, distributor website, distributor address, signature authorization, annual product sales distributor ratings, and any other data considered relevant. A distributor may be an IT product and solution provider, who maintains rights to distribute specified products for a vendor. IT products of a vendor may include software, hardware, and any other products provided by the distributor. A distributor may input distributor product information into the information database, as well as, products and vendors represented by the distributor and geographic location. The distributor product information may include system compatibility, price, warranty services, customer support, availability, delivery time, and any other data considered relevant. The system saves the information concerning the distributor profile and allows the distributor to update the profile as needed or prompts the vendor to update the vendor profile when needed. As distributor product offerings change, the distributor product information will also change. This requires that the distributor update the distributor product information to allow the system to efficiently search and correlate products and solutions to the customer's project needs at a given point in time. FIG. 7 illustrates a distributor input screen for use with the current invention. However, it is understood that other input screens and information may be incorporated without deviating from the overall scope of the invention.

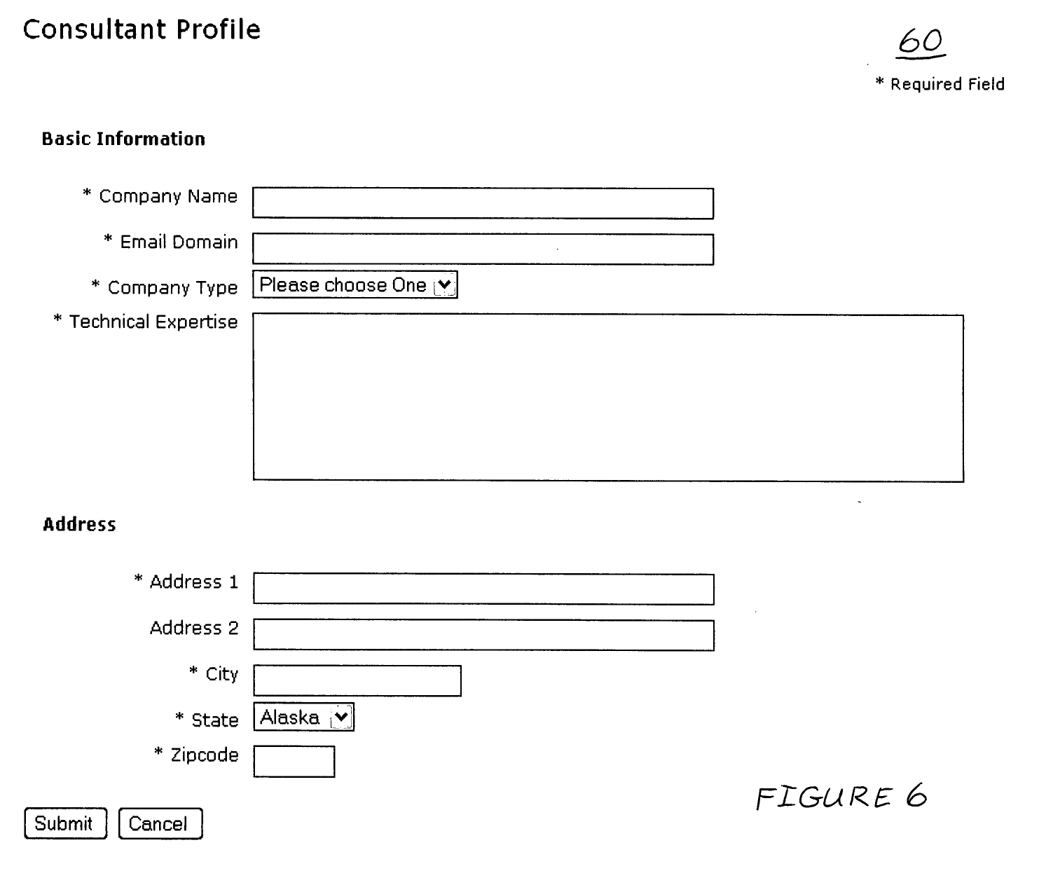

Consultant profile information may include consultant name, consultant contacts, consultant organizational structure, type of legal entity, size, consultant website, consultant address, signature authorization, annual product sales, consultant ratings, and any other data considered relevant by the consultant. A consultant may be an IT service provider, who provides services to support IT systems and network solutions. IT services may include trouble shooting, network repair, and any other services provided by a consultant. A consultant may input consultant product information into the information database. The consultant product information may include system skills, experience, price, geographic location, availability, and any other data considered relevant. The system saves the information concerning the consultant profile and allows the consultant to update the profile as needed or prompts the consultant to update the consultant profile when needed. As consultant product offerings change, the consultant product information will also change. This requires that the consultant update the consultant product information to allow the system to efficiently search and correlate services to the customer's project needs at a given point in time. FIG. 6 illustrates a consultant input screen for use with the current invention. However, it is understood that other input screens and information may be incorporated without deviating from the overall scope of the invention.

The system and method preferably comprises a request for quote and quotation for use by the sellers and customer to finalize a transaction for goods and/or services.

The vendors, distributors and consultants dictate and control the specification information of the products and solutions in the information database. However, the system controls the correlation of a product or solution to a project and utilizes discreet factors in the selection process including customer ratings, Expert ratings, customer weighted preferences, geographic location, reliability, customer support and other criteria, which is described in more detail below.

In a preferred embodiment, the customer inputs the customer project information into a customer preference manager, which allows the customer to review and modify the customer project information as necessary. Further, the customer may add, edit or remove project specification data to allow the customer an opportunity to refine the details of the project. FIG. 8 illustrates a project creation input screen for use with the current invention. However, it is understood that other input screens and information may be incorporated without deviating from the overall scope of the invention. After the customer confirms the project specification data, the customer may assign weight to each detail of the project specification data to further refine the process of correlation between the project information to a recommendation. The customer may adjust the weight of each the detail to allow a review of different scenarios under which the system may display recommendations. For example, the assigned weight may be a system that provides a weight from 1 (least important) to 10 (most important) which assigns a weight from least important project specification detail to most important project specification detail. However, it is understood that any weight system may be incorporated to achieve the purpose of assisting the customer in providing accurate project specification data that enables the present invention to display at least one selected product, if available, and accurately correlate the needs of a customer project. The customer may save the assigned weights for a given scenario for future reference and consideration. In the event a selected product is not found, the customer may edit the customer project information until at least one selected product is correlated to the project by the weighted recommendation engine.

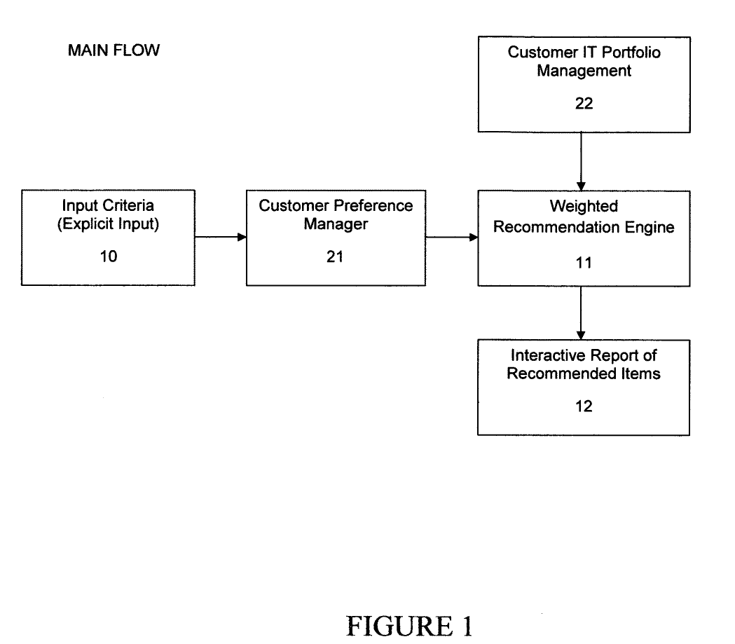

An example of the customer preference manager 21 is illustrated in FIG. 1. The customer inputs criteria 10 into the customer preference manager 21. The weighted recommendation engine 11 reviews the criteria and produces a report 12 having the recommendation(s). The system may further comprise a customer IT portfolio manager 22, which catalogues the inventory of IT resources, and the configurations, that are implemented in a computer network identified by the customer. This enables to weighted recommendation engine 11 to compare available IT solutions against existing IT resources, prior to producing the report 12.

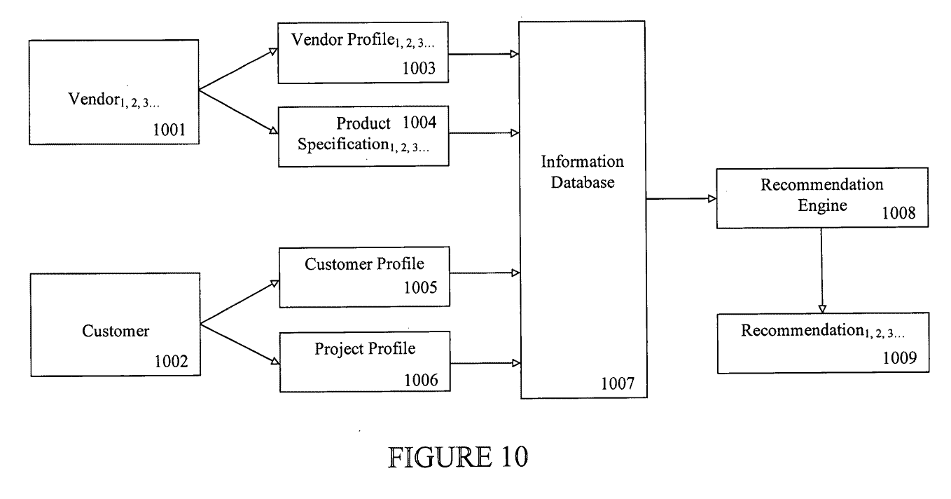

Referring to FIG. 10, a preferred embodiment of the invention is a system for correlating a customer 1002 having a project to at least one recommendation 1009, which may include at least one vendor 1001 having at least one vendor product, wherein each vendor inputs the vendor profile information 1003 and product specification information 1004. A customer 1002 creates a project and the system correlates the project profile information 1006 with at least one recommendation 1009, which preferably comprises at least one vendor and at least one product. The system preferably comprises means for inputting and displaying customer profile information 1005, wherein an information database 1007 stores the customer profile information 1005; means for inputting customer project profile information 1006 into the information database 1007, the customer project profile information 1006 preferably comprises project specification data detailing the project parameters; means for displaying vendor profile information 1003 to the vendor, the vendor profile information 1003 preferably comprises vendor identity information, wherein the information database 1007 stores the vendor profile information 1003; means for inputting at least one vendor product profile 1004 into the information database 1007. The recommendation engine 1008 of the system preferably processes the vendor profile information 1003, product specification information 1004, customer profile information 1005 and project profile information 1006 in the information database 1007 to correlate the project to at least one recommendation 1009 and displays each of the recommendations 1009 to the customer 1002. The recommendation 1009 may be a selected product that meets the needs of the project. Also, the recommendation may also include output information, such as articles, links to websites, product descriptions and the like.

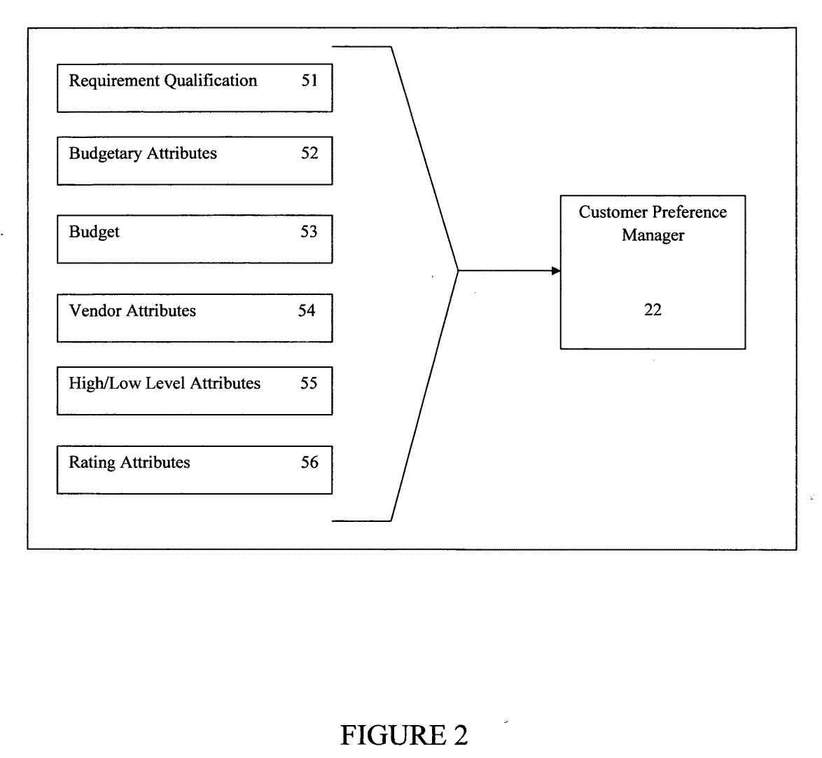

Examples of criteria for a customer project specification are provided below. The details may be pre-defined by the system for different details of the project specification. Based on the weights selected by the customer from the details of the project specification, a recommendation engine may search for products and solutions which are tagged against those details. The recommendation engine may filter out products and solutions that do not match the details of the project specification. Referring to FIG. 2, here is the brief overview of an example of such details that may assist the customer during the input process:

Requirement Qualification 12: These details allow the customer to use requirement type questions to search for products and solutions. These high level questions help the customer to focus the needs of the project to specific products and solutions.
Budgetary Attributes 52: These pre-defined details allow customer to specify any other details that could increase or decrease the overall price of the products or solutions. These details not only help to get the target price range, but could also filter out the details which do not have these values.
Budget 53: This detail allows recommendation engine to filter out products and solutions that fall outside the price range provided by the customer. The customer may use a budgetary filter in the recommendation engine to limit the selection results for a given project. The customer may either a) specify a fixed budget amount to which the recommendation engine must adhere, or b) specify a budget amount with an allowable percentage variance.
Vendor Attributes 54: These details concern vendors who potentially could provide products and solutions to the customer. The customer may select these details to narrow down the specifics of vendor. For example, the customer may specify a vendor who has been in the market for more than five years.
High/Low Level Attributes 55: These are technical details of the project and each product or solution could contain these technical details, as not all details are mandatory. These details are classified as high level and low level, where high level are most common technical details that would define the product or solution, whereas low level details would list all the possible detail the product or solution may have. The recommendation engine may use detail values provided by customer to filter out the products and solutions that do not match the values.
Rating Attributes 56: These details allow customer to filter out products and solutions based on ratings for the products or solutions.

The system and method may further include a methodology for various ratings of the goods and services by weighing various factors in various categories.

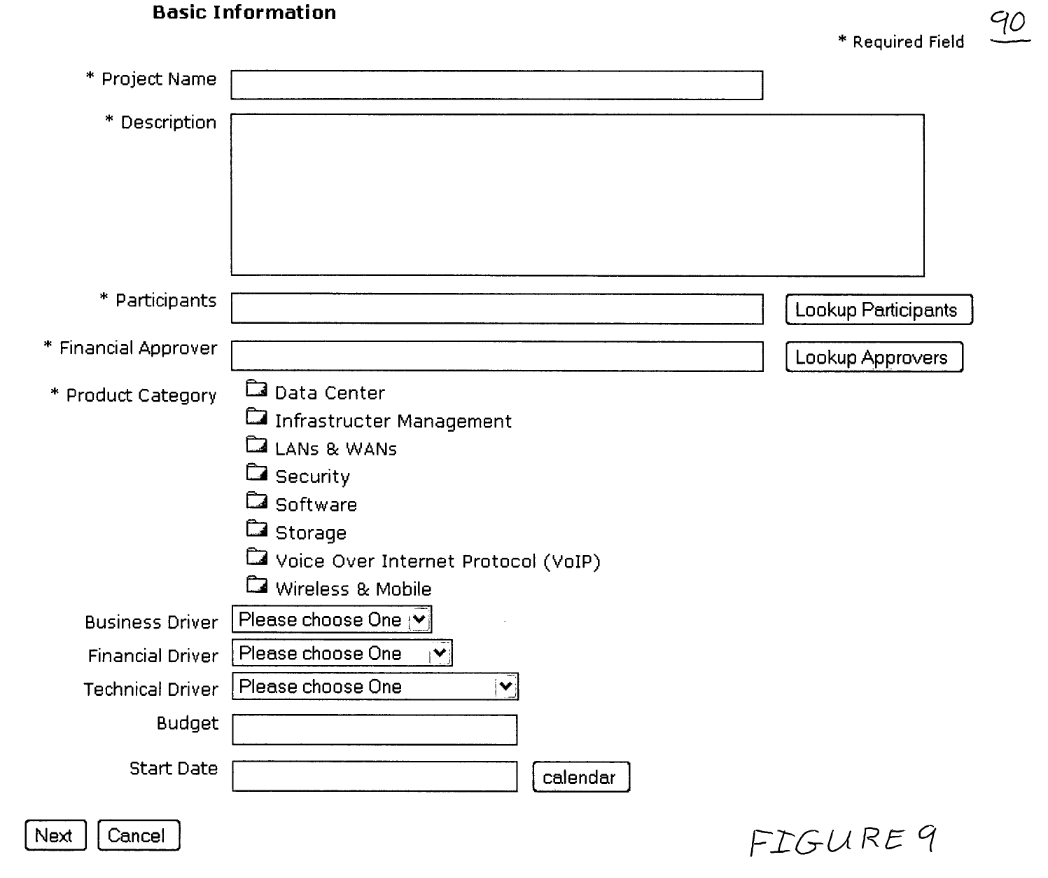

Factors that may be considered positive criteria when correlating a customer project to a product include 1) a generally favorable opinion about the vendor's ability to compete in the market; 2) customer generated inquiries about the vendor, distributor, consultant and product; 3) the vendor, distributor or consultant causes clients to change or delay their procurement plans for competing products; 4) the vendor, distributor or consultant is regarded as a serious threat by competitors; 5) the vendor, distributor or consultant regularly appears on shortlists for a selected product; 6) the vendor, distributor or consultant demonstrates a competitive presence and sales to customers; and 7) customers consider aspects of the product execution and vision are important enough to merit inclusion. Referring to FIG. 9, factors that may be considered negative criteria when correlating a customer project to a project include 1) a product has not been on the market for a sufficient enough time to establish a visible, competitive position; 2) vendor, distributor or consultant may have been asked to be included but did not reply to a request for profile and product information; 3) vendor, distributor or consultant may have a negligible apparent market share among customers; 4) vendor, distributor or consultant is not the original manufacturer of the product, which includes resellers, who repackage products that would qualify from their original manufacturers, as well as carriers and internet service providers (ISPs), which provide managed services; 5) product may be sold primarily in another product category with minimal or negligible related features to the product category required for the project; and 6) product is sold as a stand-alone for other purposes. FIG. 9 illustrates a product creation input screen for use with the current invention. However, it is understood that other input screens and information may be incorporated without deviating from the overall scope of the invention.

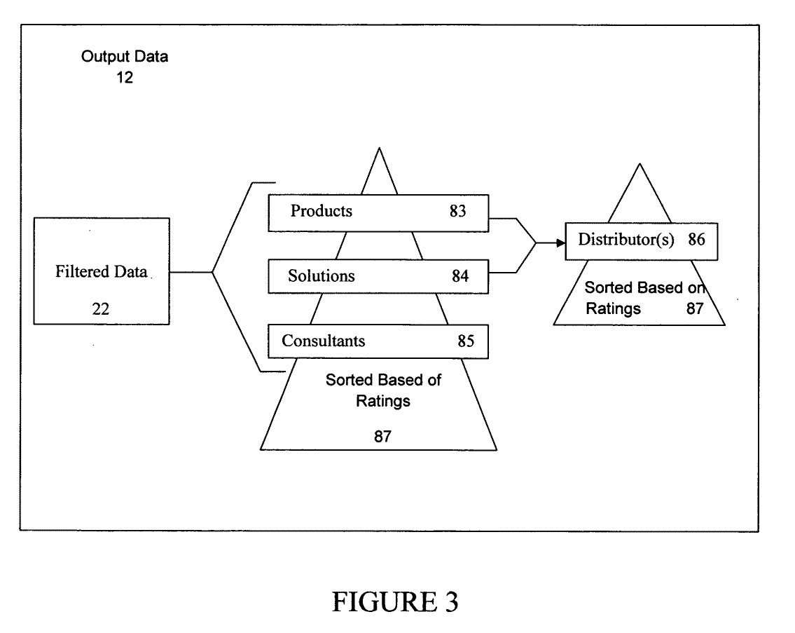

The system and method of the present invention may include several types of ratings, such as execution rating, product rating and seller rating. At least one of the ratings is preferably incorporated into the search and correlation of products best suited for a customer project. Referring to FIG. 3, the recommendation engine displays recommendations based on the weighted preferences and ratings inputted by system users, i.e. system internal analysts, customers, vendors, consultants and distributors

Referring to Table 1, as part of the rating production, the system and method provide an execution rating which rates the ability of the vendor, distributor or consultant to meet the needs of the project. For example, a factor in the execution rating may include customer experience, which describes relationships and programs that enable customers to be successful with the products. Specifically, this includes the ways customers receive technical support or account support from the vendor, distributor or consultant. This may also include ancillary tools, customer support programs (and the quality thereof), availability of user groups and service-level agreements. Another factor in the execution rating may be market responsiveness and track record, which describes the ability to respond, change direction, be flexible and achieve competitive success as opportunities develop, competitors act, customer needs evolve and market dynamics change. This factor may also consider the history of responsiveness by the vendor, distributor or consultant. Another factor in the execution rating may be marketing execution, which describes the clarity, quality, creativity and efficiency of programs designed to deliver the vendor/distributor/consultant message to influence the market, promote the brand and business, increase awareness of the products, and establish a positive identification with the product in the minds of customers. This “mind share” can be driven by a combination of publicity, promotion, thought leadership, word-of-mouth advertising and sales activities. Another factor in the execution rating may be products offered by the vendor, distributor or consultant, which may be core goods and services that compete in a defined market. This includes current product capabilities, quality, feature sets and skills. Another factor in the execution rating may be sales execution/pricing, which describes the capabilities in all pre-sales activities and the structure that supports the activities. This may include deal management, pricing and negotiation, pre-sales support and the overall effectiveness in the information database. Another factor in the execution rating may be operations, which describes the ability of the vendor/distributor/consultant to meet established goals and commitments. Factors include the quality of the organizational structure including skills, experiences, programs, systems and other vehicles that enable the vendor/distributor/consultant to operate effectively and efficiently on an ongoing basis. Another factor in the execution rating may be overall viability, which provides an assessment of the overall financial health, the financial and practical success of the business unit, and the likelihood of the individual business unit to continue investing in the product, to continue offering the product and to advance the state of the art within the portfolio of products. The standard weight of each execution rating criteria may be adjusted to allow a review of different scenarios under which the system may display recommendations. For example, the assigned weight may be a system that provides a weight from 1 (least important) to 10 (most important) which assigns a weight from least important project specification detail to most important project specification detail. However, it is understood that any weight system may be incorporated by a user.

TABLE 1

| Execution Rating Criteria | Weighting |
|---|---|
| Customer Experience | Standard |
| Market Responsiveness/Track Record | Standard |
| Marketing Execution | Standard |
| Product/Service | Standard |
| Sales Execution/Pricing | Standard |
| Operations | Standard |
| Overall Viability (Business Unit, Financial, | Standard |
| Strategy, Organization) | |

Referring to Table 2, as part of the rating production, the system and method provide a product rating which rates the ability of the seller product offerings for the needs of the project. For example, a factor in the product rating may include market understanding, which describes the ability of the seller to understand a customer's wants and needs and to translate those into goods and services. Sellers that show the highest degree of vision listen and understand the customers' wants and needs and can shape or enhance those with their added vision. Another factor in the product rating may include marketing strategy of the seller, which describes a clear, differentiated set of messages consistently communicated throughout the seller's organization and externalized through the seller's website, network product space, advertising, customer programs and positioning statements. Another factor in the product rating may include sales strategy, which describes the strategy for selling product that uses the appropriate network of direct and indirect sales, marketing, service and communication affiliates that extend the scope and depth of market reach, skills, expertise, technologies, services and the customer base. Another factor in the product rating may include product offering strategy, which describes the seller's approach to product development and delivery that emphasizes differentiation, functionality, methodology and feature set as the seller maps to current and future requirements. Another factor in the product rating may include business model, which describes soundness and logic of the seller's underlying business proposition. Another factor in the product rating may include vertical industry strategy, which describes the seller's strategy to direct resources, skills and offerings to meet the specific needs of individual market segments, including verticals. Another factor in the product rating may include seller's innovation, which describes direct, related, complementary and synergistic layouts of resources, expertise or capital for investment, consolidation, defensive or pre-emptive purposes. Another factor in the product rating may include geographic strategy, which describes the seller's strategy to direct resources, skills and offerings to meet the specific needs of geographies outside the “home” or native geography, directly or through partners, channels and subsidiaries as appropriate for that geography and market. The standard weight of each product rating criteria may be adjusted to allow a review of different scenarios under which the system may display recommendations. For example, the assigned weight may be a system that provides a weight from 1 (least important) to 10 (most important) which assigns a weight from least important project specification detail to most important project specification detail. However, it is understood that any weight system may be incorporated by a user.

TABLE 2

| Product Rating Criteria | Weighting |
|---|---|
| Market Understanding | Standard |
| Market Strategy | Standard |
| Sales Strategy | Standard |
| Product Offering Strategy | Standard |
| Business Model | Standard |
| Vertical/Industry Strategy | Standard |
| Innovation | Standard |
| Geographic Strategy | Standard |

Referring to Table 3, as part of the rating production, the system and method provide a product rating which rates the seller's ability to meet the needs of the project, which may be divided into 4 categories. For example, a factor in the seller rating may include sellers considered as leaders in the field, who demonstrate balanced progress and effort on all execution and vision categories. The actions of the leader raise the competitive bar for all products in the market, and they can change the course of the industry. The sellers must excel in product category and dominate in sales. A leading seller is not a default choice for every customer and is cautioned to not assume that the leaders produce preferred products. Some customers may feel that leaders are spreading efforts too thinly and not pursuing their special needs. Another category is challengers, who have solid products that address the typical needs of the market with strong sales, visibility and clout that add up to higher execution than niche players. Challengers are good at winning contracts, but they do so by competing on basic or a limited selection of functions rather than on advanced features. Challengers are efficient and expedient choices for defined problems. Many customers consider challengers to be the conservative, safe alternative to niche players. Another category is visionaries, who invest in the leading/“bleeding”-edge features that will be significant in the next generation of products and will give customers early access to improved functionality. Visionaries can affect the course of technological developments in the market, but lack the execution influence to outmaneuver challengers and leaders. Customers pick visionaries for best-of-breed features, and in the case of small vendors, may enjoy more personal attention. Another category is niche players, who offer viable, dependable solutions that meet the typical needs of customers, and fare well when given a chance to compete in a product evaluation. Niche players respond to market changes and new technologies, but generally lack the clout to change the course of the market. Niche players may serve conservative and risk-averse customers more efficiently than the leaders. Customers tend to pick niche players when stability and focus on a few important functions and features are more important than a wide and long road map. The standard weight of each seller rating criteria may be adjusted to allow a review of different scenarios under which the system may display recommendations. For example, the assigned weight may be a system that provides a weight from 1 (least important) to 10 (most important) which assigns a weight from least important project specification detail to most important project specification detail. However, it is understood that any weight system may be incorporated by a user.

TABLE 3

| Seller Rating Criteria | Weighting |
|---|---|
| Leader | Standard |
| Challenger | Standard |
| Visionaries | Standard |
| Niche Players | Standard |
| Business Model | Standard |

The system allows the customer to weigh each factor of each rating criteria according to the wants and needs of the customer. The customer may run several different searches for a single customer project, wherein the customer varies the weight of each factor. Certain ratings are developed through customer comments. The rating is generated by the system using customer comments regarding vendors, distributors, consultants and products.

The customer will have the opportunity to rate and provide feedback on a range of attributes regarding potential products and solutions to produce external ratings. External ratings may be continually be updated based on the ongoing performance of a product. The feedback will be available for display to the customer. The customer may use specific attributes of the external ratings for consideration by the recommendation engine in the product and solution selection process. Expert ratings are developed by impartial analysts who rate product functions and performance and vendor/consultant/distributor characteristics. Expert ratings may be continually updated based on the ongoing performance of a product or solution. The customer may use specific attributes of the external ratings for consideration by the recommendation engine in the product and solution selection process. The specifics of the external user ratings and expert ratings may be saved in the information database based on an objective analysis of the defined attributes. The weight of each attribute may be adjusted by a user or internal analyst, as applicable and as necessary for an accurate rating. For example, the assigned weight may be a system that provides a weight from 1 (least important) to 10 (most important) which assigns a weight from least important project specification detail to most important project specification detail. However, it is understood that any weight system may be incorporated

While the invention has been illustrated in detail in the drawings and the foregoing description, the same is to be considered as illustrative and not restrictive in character as the present invention and the concepts herein may be applied to any customer/vendor scenario which requires correlation of customer needs to products and services and develop ratings for use in the correlation. It will be apparent to those skilled in the art that variations and modifications of the present invention can be made without departing from the scope or spirit of the invention. Thus, it is intended that the present invention cover all such modifications and variations of the invention that come within the scope of the appended claims and their equivalents.

We claim:

1. A system for correlating a customer having a project with a recommendation:
means for inputting customer profile information;
means for displaying customer profile information to said customer, wherein an information database stores said customer profile information;
means for inputting customer project information into said information database, said customer project information comprising a project specification detailing said project;
means for inputting vendor profile information;
means for displaying vendor profile information to a vendor, said vendor profile information comprising vendor identity information, wherein said information database stores said vendor profile information;
means for inputting at least one vendor product specification into said information database;
wherein said system develops at least one rating for each of said product specification; and
wherein said system processes project information in said information database to correlate said project information to said recommendation and displays said recommendation to said customer.

2. The system of claim 1, said recommendation comprising least one selected product.

3. The system of claim 1, further comprising:
means for inputting consultant profile information;
means for displaying consultant profile information to a consultant, said consultant profile information comprising consultant identity information, wherein said information database stores said consultant profile information;
means for inputting at least one consultant product specification into said information database;
means for inputting distributor profile information;
means for displaying distributor profile information to a distributor, said distributor profile information comprising distributor identity information, wherein said information database stores said distributor profile information; and
means for inputting at least one distributor product specification into said information database.

4. The system of claim 2, said recommendation comprising at least one solution.

5. The system of claim 4, said solution comprising a plurality of selected products, wherein said plurality of selected products is used in combination to meet the requirements of said project.

6. The system of claim 2, further comprising a customer preference manager.

7. The system of claim 1, further comprising:
means for assigning preference weight to each detail of said project specification.

8. The system of claim 1, said customer profile information comprising existing information technology resources of said customer.

9. The system of claim 6, said rating comprising at least one of an execution rating, product rating and seller rating.

10. The system of claim 3, said information database comprising a customer database, a vendor database, a distributor database and a consultant database.

11. The system of claim 10, wherein said customer database comprises:
customer profile information; and
customer project information.

12. The system of claim 3, further comprising means for inputting at least one rating for at least one of said vendor, distributor, consultant and product.

13. The system of claim 6, said rating comprising at least one of an expert rating and an external user rating.

14. A method for correlating a customer having a project with a recommendation comprising:
inputting customer profile information;
displaying customer profile information to said customer, wherein an information database stores said customer profile information;
inputting customer project information into said information database, said customer project information comprising a project specification detailing said project;
inputting vendor profile information;
displaying vendor profile information to a vendor, said vendor profile information comprising vendor identity information, wherein said information database stores said vendor profile information;
inputting at least one vendor product specification into said information database;
developing at least one rating for each of said product specifications; and
processing project information in said information database to correlate said project information to said recommendation and displays said recommendation to said customer.

15. The method of claim 14, further comprising:
inputting consultant profile information;
displaying consultant profile information to a consultant, said consultant profile information comprising consultant identity information, wherein said information database stores said consultant profile information;
inputting at least one consultant product specification into said information database;
inputting distributor profile information;
displaying distributor profile information to a distributor, said distributor profile information comprising distributor identity information, wherein said information database stores said distributor profile information; and
inputting at least one distributor product specification into said information database.

16. The method of claim 15, further comprising correlating each of said profile information to comprise at least one rating.

17. The method of claim 14, said recommendation comprising least one selected product.

18. The method of claim 17, said recommendation comprising at least one solution.

19. The method of claim 18, said solution comprising a plurality of selected products, wherein said plurality of selected products is used in combination to meet the requirements of said project.

20. The method of claim 17, said recommendation further comprising output information.
